(19) United States
(12) Patent Application Publication
(10) Pub. No.: US 2004/0015982 A1
(43) Pub. Date: Jan. 22, 2004

(54) Electronic user pays product and/or service controller

(76) Inventor: Ian Charles Bailey, Auckland (NZ)

Correspondence Address: BIRCH STEWART KOLASCH & BIRCH, PO BOX 747, FALLS CHURCH, VA, 22040-0747, US

(21) Appl. No.: 10/275,655

(22) PCT Filed: May 9, 2001
(86) PCT No.: PCT/NZ01/00083

(30) Foreign Application Priority Data
May 9, 2000 (NZ) 504441

(51) Int. Cl. H04N 7/16; H04N 7/173; G06F 3/00; H04N 5/445

(52) U.S. Cl. 725/1; 725/104; 725/5; 725/61

(57) ABSTRACT

A method and an apparatus 5 for monitoring and controlling the provision of user pays products and/or services is provided. The apparatus may interface with a meter 6 of a supply network or supply channel and control the supply of user pays products and/or services. The apparatus receives communications from host system 7 including configuration data that is specific to a user of the product or service and/or specific to the user pays product or service.

### TECHNICAL FIELD

This invention relates to an electronic user pays product and/or service controller and in particular, but not exclusively to an electronic user pays product and/or service controller that enables customisation of user-pays products and/or services to a site.

### BACKGROUND

Numerous products and services are now offered to households and businesses on a user-pays basis. A supply network is provided to supply the goods or services and the customer subscribes to or connects to the supply network to extract the product or service and subsequently pays on a per unit usage basis.

Meters are often provided to measure a quantity of product or service which has been consumed at the site. For example, gas, water and electricity meters are used to measure the usage of those products so that the customers may be billed appropriately. Similar meters have been developed which apply to the use of electronic information including, for example pay-TV or other wireless services, and internet access.

One problem with existing systems is that only crude monitoring and control means are available to both the users and the suppliers. Suppliers typically can sever a supply of the goods or services to an individual site and similarly, the user can also sever the supply if required. However, typically there is no means of distinguishing between individual users at a single site and the control of the provision of the services to the site is typically dictated by company policy and provides little flexibility according to any customer requirements or agreement between the supplier and the customer. Further, there is no method of remotely controlling the pricing parameters.

### OBJECT OF THE INVENTION

Thus, it is an object of the present invention to overcome or at least alleviate problems in monitoring and control systems for user pays product or service provisions at present, or at least to provide the public with a useful choice.

Further objects of the present invention may become apparent from the following description.

### SUMMARY OF THE INVENTION

According to one aspect of the present invention, there is provided apparatus for monitoring and controlling the provision of user-pays products and/or services to a site, the apparatus including:

interface means adapted to interface with one or more user-pays supply networks or channels and monitor the consumption of at least one user-pays product and or service through said one or more supply networks or channels;

supply control means adapted to directly or indirectly control the supply of said at least one user-pays product or service to the site;

communication means for receiving configuration data from a remote source;

processing means adapted to process the configuration data and communicate with the supply control means, and thereby control the provision of the user-pays product or service to the site depending on configuration data;

wherein the configuration data is specific to the or each user-pays product and/or service and/or specific to one or more users at the site.

Preferably, the apparatus may be adapted to interface with an existing monitor of a user-pays supply network thereby providing the interface means with the supply network.

Preferably, the apparatus may include a user interface whereby individual users can identify themselves using a predetermined identification means, wherein once the user is identified, configuration data relating to that user is communicated to the apparatus through the communication means.

Preferably, the identification means may include a swipe card or smart card.

Preferably, the apparatus may be adapted to communicate with a transaction network whereby users may make payments towards one or more user-pays products or services through the transaction network.

Preferably, the user interface may be adapted to allow selection of one or more user-pays products or services by a user, wherein configuration data is communicated to the apparatus relating to that user-pays product or service through the communication means dependent on said selection.

Preferably, the user interface may allow each user to enter a password identifying themselves to the apparatus and/or to a central database.

Preferably, the processing means may be adapted to allocate charges to an account of each user depending on the provision of user-pays goods and/or services to the site associated with each user.

Preferably, the allocation of charges to user accounts may be dependent on which users have identified themselves using the user interface.

Preferably, the allocation of charges to user accounts may be dependent on the configuration data.

Preferably, the configuration data may include charging information defining whether the cost of the provision of the user-pays product or service is to be shared between all users associated with a site or users who have identified themselves through the user interface.

Preferably, the configuration data may include information whether a user is permitted to operate in credit and the maximum credit limit allowed.

Preferably, the configuration data may include pricing structure information including a plurality of rates of changes, each to be used under specified conditions.

Preferably, the apparatus may include disconnection means to disconnect the provision of the product or service at the command of the product or service provider, received through the communication means.

According to another aspect of the present invention, there is provided a method for monitoring and controlling the provision of user-pays products and/or services to a site, the method including:

interfacing with at least one user-pays supply network or channel and monitoring the use of one or more user-pays products and/or services through said at least one supply network or channel;

providing supply control means adapted to control the provision of said one ore more user-pays product or service to the site,

receiving configuration data from a remote source;

controlling the provision of the user-pays product or service to the site depending on configuration data;

wherein the configuration data is specific the or each user-pays product and/or service in use and/or specific to one or more users at the site.

Preferably, the method may further include identifying users that are using the user-pays products and/or services using a predetermined identification means, wherein once the user is identified, configuration data relating to that user is communicated to the apparatus through the communication means.

Preferably, the apparatus may include a user interface adapted to allow selection of one or more user-pays products or services by a user, wherein after a product or service has been selected configuration data is communicated to the apparatus relating to that user-pays product or service through the communication means.

Preferably, the method may further include charging for the provision of the user-pays products and/or services depending on the configuration data.

Further aspects of the present invention may become apparent from the following description, given by way of example only and in which reference is made to the accompanying drawings.

### BRIEF DESCRIPTION OF THE DRAWINGS

FIG. 1: shows a block diagram representation of the apparatus of the present invention in a user-pays system according to one aspect of the present invention; and

FIG. 2: shows a block diagram of the apparatus of the present invention in a system with multiple user-pays products and services.

### DESCRIPTION OF PREFERRED EMBODIMENTS OF THE INVENTION

The apparatus of the present invention allows increased flexibility in the provision of user-pays products and/or services to a single site. Traditionally, only an overall control of supply of a service to a site has been available, with either the supplier or any one of the users being able to disconnect the service.

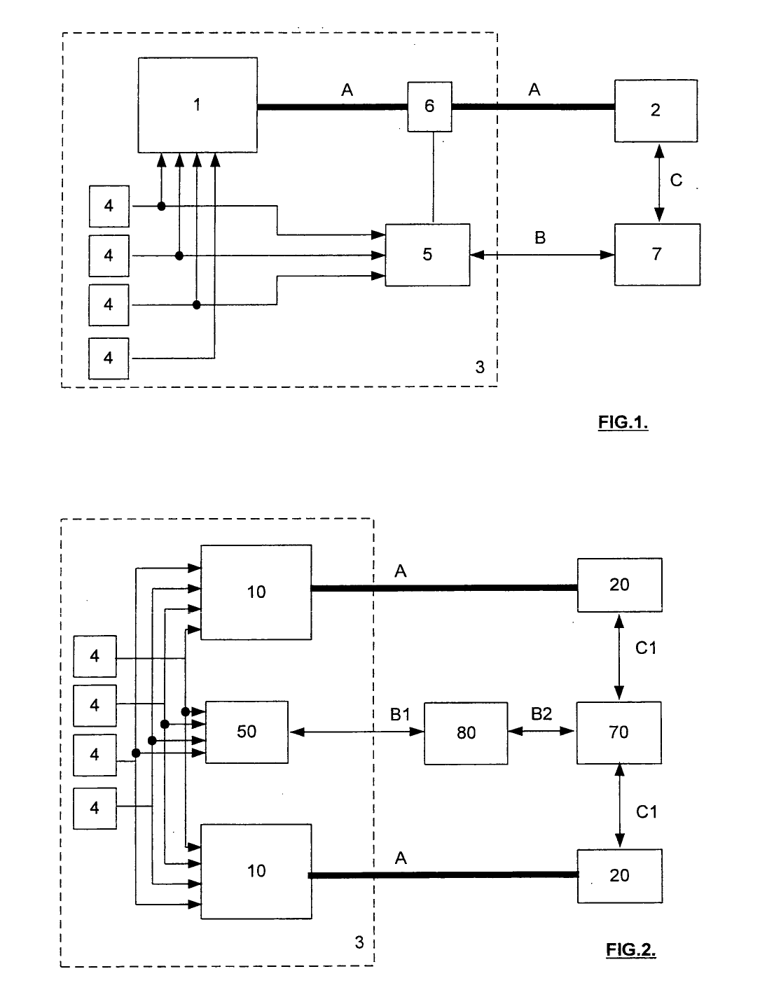

Referring to FIG. 1 of the accompanying drawings, a simplified block diagram of an apparatus for monitoring and controlling the provision of user-pays products and/or services according to the present invention is shown connected to a user-pays product or service system. An appliance 1, which consumes a user-pays product or service from a supplier 2 is provided at a site 3. The product or service is supplied through a supply network or direct supply line, with the supply channel being generally referenced by line A. For example, supply channel A may represent a direct physical line, a wireless communication channel, a particular route through a supply network, which may be a wired, cabled, pipelined or wireless network. The site 3 may be a household, a commercial premises, industrial premises or other site where there is the provision of user-pays products or services.

One or more users 4 of appliance 1 are identified for the site 3. Each user may be identifiable by a suitable identification means, for example a password or an identification card. Using the identification means, each user can identify themselves to a monitoring and control apparatus 5 through a suitable user interface. The user interface may be provided at the same location as the apparatus 5, or may be located elsewhere depending on requirements. For example, an interface may be provided on or near each appliance 1.

The monitoring and control apparatus 5 for monitoring and controlling provision of the products and/or services to appliance 1 is connected to a meter 6. It will be appreciated that the controller 5 may be connected to any part of the supply channel A between the appliance 1 and supplier 2 and may include its own meter. However, given that many user-pays products and services already have adequate meters, it is convenient to interface to the system by connecting the control apparatus 5 to such a meter.

The control apparatus 5 includes a means to communicate with a host system 7 to allow transfer of a user and/or device profile stored within the host system to the control unit, the communication channel being represented by arrow B.

The monitoring and control apparatus 5 is also communicatively connected to a control means to enable control over the supply of products or services through supply channel A. In FIGS. 1 and 2 the control means is either located within the meter 6 or at the supplier 2. The control apparatus 5 communicates with the meter 6 directly or with the supplier 2 through a host system 7. In an alternative embodiment, the control apparatus 5 may communicate with a separate control means located at or near the site 3. For example, in the provision of fluids, the control apparatus 5 may control a motor to open or close a valve at the site 3 and in the provision of broadcast information with the receiver of the apparatus 1.

The host system 7, which may be administered by the supplier 2, as represented by arrow C, or alternatively may be independently administered, contains a set of configuration data for the control device 5 relating to site 3, appliance 1 and/or the users 4. When a user-pays product or service is to be purchased by any one of the users 4, configuration data is downloaded from the host system 7 to the control device 5.

Depending on the appliance 1 in use, the configuration data may include a specific user profile, or one that is applicable to the entire site 3. For example, the provision of gas, water and electricity may be provided on the basis of configuration data applicable to the entire site 3, whereas the provision of pay-TV may be individualised to each user 4. It is anticipated that essential products and/or services would typically be paid for by all users 4, whereas inessential services, like pay-TV may be applicable to individual users 4. Also, the configuration data may include information specific to the appliance 1 in use, allowing for example, different charging rates for the same products or services depending on the appliance 1, time of day, current demand or other variable.

In one embodiment of the invention, the control device 5 may include processing means to calculate a charge corresponding to the per unit usage measured by the meter 6. This may be charged to a user account, which may be stored locally within the apparatus 5, or remotely, for example in the host system 7. In a further alternative embodiment, the account information may be stored temporarily in apparatus 5 and communicated at predetermined intervals to the host system 7.

Each user 4 may identify themselves to the control device 5 and obtain a balance of their account for each product or service associated with each user-pays appliance within the site 3. Furthermore, each user within the site 3 may choose to pay for a product or a service at a specific time or, alternatively a group of users 4 may choose to each contribute an amount towards the provision of the product or service. For example, in the case of Internet access, if three people are working on the internet at the same time, each may identify themselves to the control device 5, which will divide the cost of the product or service between the users 4. Optionally, the control device 5 may allow a proportion of the cost of any Internet access to be distributed at predetermined ratios as may be defined in the configuration data from host system 7 and/or entered by the users 4 through an interface of the control device 5.

The control device 5 may include an interface with a transaction network, so as to allow payment for the products or services. For example, the control device 5 may permit electronic payment by credit card, smart card or other means.

Referring now to FIG. 2, a block diagram of a control apparatus 50 controlling the provision of multiple products and/or services is shown. The control apparatus 50 is similar to control apparatus 5, but is adapted to interface with multiple user-pays provision networks and/or multiple appliances 10. In FIG. 2, the control device 50 includes a meter to monitor the usage of the products and/or services. The control device 50 may alternatively interface with a monitor or meter as for control device 5. The control device 50 communicates with host system 70 through a communications network 80, for example a telecommunications network such as the Internet or a wireless communications channel. This is represented by communication lines B1 and B2 respectively.

In the embodiment shown in FIG. 2, the host system 70 administers the provision of products or services from multiple suppliers 20, and may have its own independent administrator which communicates with suppliers 20 through an appropriate communication channel referenced C1. C1 may be a telecommunications network for voice or data information or any other appropriate communication channel. Alternatively, each supplier 20 may include its own host system, which may comprise a server and a database containing configuration data relating to each appliance 10 and/or each user 4.

In a preferred embodiment of the invention, the users 4 may be able to access specific variables of the configuration data through the communications network 80, or some other appropriate communication system so that they may vary the configuration data relating to the provision of their products and/or services. Some variables may be fixed by the supplier 20, and not able to be changed by the user for example, whether a user is allowed to use the products or services on credit and the extent of the credit.

In addition to monitoring and controlling use of the user-pays products and/or services for billing purposes, the control apparatus 50 may also include an option to enforce a block based on some characteristic of the identified user or users 4. For example a block may be enforced on any products or services which can not be provided to persons below a certain age. R-rated movies, may have restricted access or the provision of gas to a cooker may be restricted to persons over a certain age for safety purposes.

In a further application of the present invention, a user may identify themselves at any site which has a control apparatus 50 in communication with a supplier 2 or 20. The user 4 may then purchase a user-pays product or service to be consumed at any site 3. To enable this application, it is preferable that each user account is held by each supplier 2 or 20, or at least in a central database.

Thus, there is provided a control apparatus which allows configuration of the conditions under which a user-pays product and/or service will be provided. The device allows increased flexibility for the needs of each user and supplier.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention.

1. Apparatus for monitoring and controlling the provision of user-pays products and/or services to a site, the apparatus including:
interface means adapted to interface with one or more user-pays supply networks or channels and monitor the consumption of at least one user-pays product and or service through said one or more supply networks or channels;
supply control means adapted to directly or indirectly control the supply of said at least one user-pays product or service to the site;
communication means for receiving configuration data from a remote source; and
processing means adapted to process the configuration data and communicate with the supply control means, and thereby control the provision of the user-pays product or service to the site depending on configuration data;
wherein the configuration data is specific to the or each user-pays product and/or service and/or specific to one or more users at the site.

2. The apparatus as claimed in claim 1 adapted to interface with an existing monitor of a user-pays supply network thereby providing the interface means with the supply network.

3. The apparatus as claimed in either claim 1 or claim 2, including a user interface whereby individual users can identify themselves using a predetermined identification means, wherein once the user is identified, configuration data relating to that user is communicated to the apparatus through the communication means.

4. The apparatus as claimed in claim 3, wherein the identification means includes a swipe card or smart card.

5. The apparatus as claimed in any one of the preceding claims adapted to communicate with a transaction network whereby users may make payments towards one or more user-pays products or services through the transaction network.

6. The apparatus as claimed in any one of the preceding claims including a user interface to allow selection of one or more user-pays products or services by a user, wherein configuration data is communicated to the apparatus relating to that user-pays product or service through the communication means dependent on said selection.

7. The apparatus as claimed in claim 3, wherein the user interface allows each user to enter a password identifying themselves to the apparatus and/or to a central database.

8. The apparatus as claimed in any one of the preceding claims, wherein the processing means is adapted to allocate charges to an account of each user depending on the provision of user-pays goods and/or services to the site associated with each user.

9. The apparatus as claimed in claim 8, wherein the allocation of charges to user accounts is dependent on which users have identified themselves using the user interface.

10. The apparatus as claimed in either claim 8 or claim 9, wherein the allocation of charges to user accounts is dependent on the configuration data.

11. The apparatus as claimed in claim 3 or any one of claims 4 to 11 when dependent on claim 3, wherein the configuration data includes charging information defining whether the cost of the provision of the user-pays product or service is to be shared between all users associated with a site or users who have identified themselves through the user interface.

12. The apparatus as claimed in any one of the preceding claims, wherein the configuration data includes information whether a user is permitted to operate in credit and the maximum credit limit allowed.

13. The apparatus as claimed in any one of the preceding claims, wherein the configuration data includes pricing structure information including a plurality of rates of changes, each to be used under specified conditions.

14. The apparatus as claimed in any one of the preceding claims, wherein the apparatus includes disconnection means to disconnect the provision of the product or service at the command of the product or service provider, received through the communication means.

15. A method for monitoring and controlling the provision of user-pays products and/or services to a site, the method including:
interfacing with at least one user-pays supply network or channel and monitoring the use of one or more user-pays products and/or services through said at least one supply network or channel;
providing supply control means adapted to control the provision of said one ore more user-pays product or service to the site,
receiving configuration data from a remote source;
controlling the provision of the user-pays product or service to the site depending on configuration data;
wherein the configuration data is specific the or each user-pays product and/or service in use and/or specific to one or more users at the site.

16. The method of claim 15 further including identifying users that are using the user-pays products and/or services using a predetermined identification means, wherein once the user is identified, configuration data relating to that user is communicated to the apparatus through the communication means.

17. The method of either claim 15 or claim 16, wherein the apparatus includes a user interface adapted to allow selection of one or more user-pays products or services by a user, wherein after a product or service has been selected, configuration data is communicated to the apparatus relating to that user-pays product or service through the communication means.

18. The method of any one of claims 15 to 17, further including charging for the provision of the user-pays products and/or services dependent on the configuration data.

19. Apparatus for monitoring and controlling the provision of user-pays products and/or services to a site substantially as herein described and with reference to the accompanying drawings.

20. A method for monitoring and controlling the provision of user-pays products and/or services to a site substantially as herein described and with reference to the accompanying drawings.
